(19) United States
(12) Patent Application Publication
(10) Pub. No.: US 2002/0059574 A1
(43) Pub. Date: May 16, 2002

(54) Method and apparatus for management and delivery of electronic content to end users

(76) Inventors: Geoffrey T. Tudor, Austin, TX (US); David H. Fruhling II, Austin, TX (US); Beth A. Chauvin, Austin, TX (US); Steven W. Rose, Haliimaile, HI (US)

Correspondence Address: Irene M. Williams, Advent Networks, Inc., Suite 300E, 9600 Great Hills Trail, Austin, TX, 78759, US

(21) Appl. No.: 09/860,660

(22) Filed: May 17, 2001

Related U.S. Application Data
(60) Provisional application No. 60/205,853, filed on May 19, 2000.

(51) Int. Cl. H04N 7/16

(52) U.S. Cl. 725/1; 725/151; 725/131

(57) ABSTRACT

A method and apparatus are provided for the management and delivery of electronic/digital content including high bandwidth video, audio, games and data to end users. The electronic content is stored in an array of computer file/database servers. Integrated software systems provide subscriber management and billing, content management, security, targeting, bandwidth management, and delivery of requested content to end users. The system includes a user interface which simplifies operations for customers and tightly integrated commerce functions. The proposed method and apparatus would assist in the operation of a network that is connected to the Internet and has a plurality of customers (end users). Under current available technology, the proposed method and apparatus would best function over a wired network. However, as wireless technology becomes more robust and cost-effective, the current invention will be able to provide functionality for end users using wireless devices.

### DESCRIPTION OF RELATED ART

The invention allows management of electronic content and delivery of multiple types of content to end users. The invention allows network operators to store content of various types and manages and controls the delivery of that content. In addition, operators can increase the value of the content by bundling it with advertising and targeting particular types of content to users that would have a propensity to purchase that type of content.

While there are other types of systems that can deliver a subset of these services, none exist that provide an integrated solution encompassing all of the content storage, management, delivery, targeting, and experience functions. Additionally, no systems exist that can deliver these services to a variety of platforms such as the television, the personal computer, or wireless devices. The invention allows operators to manage all aspects of content delivery in a seamless manner.

In U.S. Pat. No. 5,956,716, Kenner, et al., discloses a system for storage and retrieval of video clips with capabilities to deliver the clip to an end user from a storage location closest to that user. In particular, Kenner proposes a storage system with video clips replicated on computer servers in various locations. The retrieval system includes a method for searching through a database to select audio-visual clips and making a request for retrieval. Additionally, the system includes an index manager that determines the exact storage location of each clip and directs the downloading of a clip from the location which is closest to the user.

In U.S. Pat. No. 6,003,030, Kenner and Karush disclose a system for deployment of mirror sites throughout a network each of which maintains a copy of certain data managed by the system. Kenner and Karush propose a system for selecting a delivery site, a downloading apparatus for downloading the file from the preferred site and a series of analytical measures to determine delivery site loading and performance.

In U.S. Pat. No. 5,644,714, Kikinis discloses a video jukebox service that includes a world-wide array of file servers interconnected by data links and having video input apparatus. Each file server has a plurality of connected clients which are notified of the availability of video clippings and clippings are downloaded onto client work stations on request. This system utilizes analog telephone modem links and Integrated Services Digital Network links for communication.

In U.S. Pat. No. 5,550,982, Long, et.al., disclose a video application server including software for managing multiple simultaneous video streams across a Local Area Network (LAN). The system includes one or more file servers connected to the LAN and one or more clients connected to the LAN.

The major problem with providing high bit rate electronic content including video, audio and data is that an integrated solution for management, distribution and financial tracking of this content does not exist. Nor is there available a unified service package that includes a user interface and can operate on multiple devices such as the television or the personal computer. While there are solutions for individual elements of content management and delivery, these solutions are not coordinated in a manner so that they function as a cohesive whole. For example, there are several alternatives for provisioning simultaneous video streams to multiple end users. However, there are no existing solutions for bundling targeted advertising with individual video streams based on the characteristics of each end user. Additionally, an integrated method for tracking delivery of the advertising and recording commerce transactions over the network which were stimulated by that advertising is not available.

To meet the increased consumer need for electronic content and to manage, track and deliver the content in coordination with a plurality of business partners, a cohesive and comprehensive method is needed. Such a solution must be able to deliver high bandwidth applications, including on-demand video and other visually rich programming.

### SUMMARY OF THE INVENTION

The present invention provides a method and apparatus for complete delivery and management of electronic content, including video, audio, and data to end users. In addition, the invention includes a series of management functions, such as targeting and advertising insertion, which enhance the value of the electronic content and allow operators to fully track content usage, advertising effectiveness, and electronic commerce transactions. Taken as a whole, this method and apparatus is referred to as the Advent Software Platform. The Platform is designed to enable end users to take advantage of an appealing user interface that can operate on various devices such as the television, the personal computer of other devices.

Perhaps the most significant distinction of the current invention is that each element of the Advent Software Platform is designed to interface seamlessly with the overall operational function, providing a complete solution for content management and delivery, targeted advertising, personalization of user preferences, and tracking of revenues generated through content-related commerce. Additionally, the financial tracking elements are designed to interface with a plurality of business partners, integrating external commerce functions with internal mechanics of electronic content management and delivery.

A Network Operating Support System functions as the primary means for content delivery and provides network management and resolution of operating problems. A Business Support System performs subscriber management and billing functions. An AAA server will be used for authentication, authorization and audit purposes. Digital assets will be managed using a content management system. This system will store, track and index metadata related to digital assets.

Permission-based targeting and profiling of end users is conducted to provide filtering of content and advertising based on viewing habits. Caching is provided for narrowband/broadband Internet use. Computer servers provide the caching. Software components provide real time formatting and transformation of web pages to various display formats to allow end users to access web pages from their television or other devices. Video and other high-end servers provide caching of video content in a format that allows immediate delivery to multiple end users. The servers incorporate stream management software that allows video content to be delivered at a speed which will ensure very high quality. Video advertisement insertion servers function in a manner similar to the video servers. Included in the platform are network management extensions that provide effective bandwidth management and address resolution protocol (ARP) which are functional elements needed to ensure that each end user has the appropriate allocated bandwidth and to effectively track the network address for each end user.

The delivery system includes a User Interface (UI) deliverable to a Set-top Box (STB) which creates a user environment through which viewers can effectively navigate through the platform and the internet, request content and conduct commercial transactions. An Experience Engine consists of software designed to deliver a personalized, branded, ergonomic look and feel to the overall services. A Shopping Engine will provide customers with convenient and simplified access to commercial shopping services.

### BRIEF DESCRIPTION OF THE DRAWINGS

FIG. 1 shows a schematic view of the Advent Software Platform.

### DETAILED DESCRIPTION OF EMBODIMENTS OF THE INVENTION

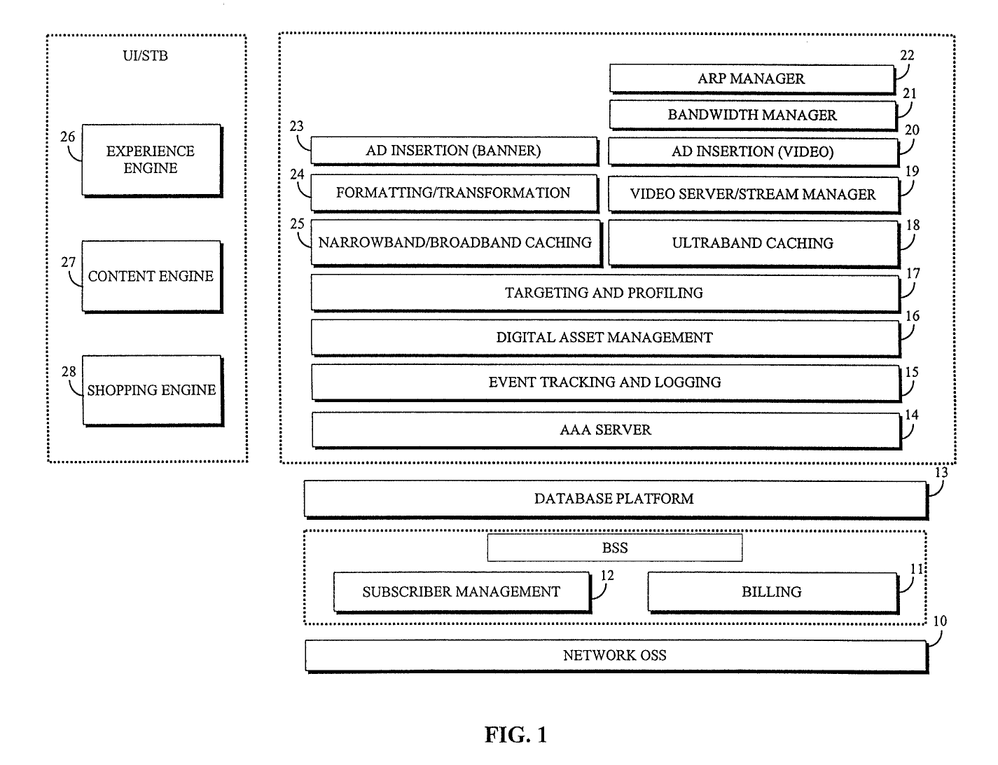

FIG. 1 represents a block arrangement for carrying out the invention, however, other methods of arrangement may be developed by those skilled in the art.

With reference to FIG. 1, the entire Advent Software Platform is supported by a Network Operating Support System (OSS). The OSS (10) performs management of the network elements and allows for troubleshooting. The OSS is the underlying software system that facilitates the delivery of electronic content to users.

A Business Support Systems (BSS) element performs subscriber management and billing functions. The BSS includes two modules, the Subscriber Management module (12) and the Billing module (11) which cover customer care, generation of trouble tickets for service calls, and order management. The BSS also tracks and assigns physical assets such as equipment located at the customer premises. The Billing system captures, rates, and generates billing information based on end user activity. The BSS exports the billing information in a format that is compatible with various service providers that provision services through the network.

A Database platform (13) provides a repository for content and other information flowing between the Content Delivery Platform and the BSS.

The Content Delivery Platform (CDP) includes a series of modules which send requested electronic content to the end user. Integrated into this activity are the recording of user preferences, generation of targeting profiles, bundling and distribution of content meeting the profile, and other functions as described below.

An AAA Server (14) or other type of authentication server is used for authentication, authorization and audit purposes. Authentication involves the confirmation of the identity of an end user. The AAA Server will compare authentication data supplied by the user at the time of a specific content request to stored authentication data and if the supplied data confirms the user identity, the content request is allowed to continue. If the user identity cannot be confirmed the AAA Server does not allow the content to be delivered and instead directs a message to the end user indicating that the system is unable to authenticate the identity. Authorization involves the evaluation of the permission for individual end users to receive certain electronic content. During the authorization process, a user's authority to receive certain content is compared with data stored in the Subscriber Management module. If the user meets predefined criteria to receive the content, the AAA Server approves the continuation of the content transfer process. If the user is not authorized to receive certain content, the AAA Server does not allow the transfer to continue and instead directs a message to the user indicating an authorization failure. The audit function tracks overall system usage by individual end users, allowing the operator to determine the quantity of overall system use by each user.

Event Tracking and Logging data (15) functions in a similar manner to the audit component of the AAA Server. However, while the AAA Server tracks overall system usage, the Event Tracking and Logging module monitors user use of specific conent types. This allows the system operator to continually reassess utilization of system elements and adjust service capabilities to match overall demand.

Content assets will be managed using a Digital Asset Management module (16). This system will store, track and index metadata related to digital assets. Metadata will include ownership, rights, time envelopes, prices and marketing data pertaining to the digital asset. Ownership refers to the business partner which is making a particular piece of content available to end users thorough the system. Time envelopes refer to the amount of time that an end user is allowed to access a particular piece of content through a single request. Time envelopes may be established by the content owner or the network operator. Following expiration of the time envelope for a piece of content, an end user will need to make a new request for delivery of the content. Prices refer to the charge to an end user to receive an individual piece of content. Marketing data includes information about a specific piece of content which is useful in establishing the propensity for end users to request that content. This information is stored in a corresponding manner with each piece of content, as appropriate. Types of content include video, audio, games, software, and other applications and services. The content can be available for down load or real time interaction.

Permission-based Targeting and Profiling of end users will be conducted using a module (17) which tracks end users preferences and develops highly-targeted content which meets those preferences. This targeting will include collaborative filtering of content and advertising based on user browsing activity and content purchases. The Targeting and Profiling module works with data provided by end users through the Subscriber Management module and data from the Event Tracking and Logging module. Upon aggregating this data, the Targeting and Profiling module builds an overall set of preferences for each user so that the operator may offer content, information, and a user experience which meets the needs of each user.

A Narrowband/Broadband Caching module (25) will provide a storage and delivery solution for content that is available in narrowband/broadband. This module will cache Internet content to allow delivery to the end user without requiring the data to come from a source external to the network. The Internet content is updated as needed to keep the information stored in the Caching module current. Providing the information through the server instead of the external Internet reduces the cost of external resources needed by the network operator and increases the speed of delivery to the end user.

An Ultraband Caching module (18) will function in a similar manner to the Narrowband/Broadband Caching Module with the exception that end users will have access to data stored in the Ultraband Cache at speeds which are much faster than those available from the Narrowband Cache server. The Ultraband Cache provides a differentiated service for those partners which desire to provide faster delivery and enhanced content richness to end users. Similar to the Narrowband server, information in the Ultraband Cache will be updated as needed by business partners to maintain current data and information. The Ultraband service operates on multiple access devices including the television and the personal computer.

A Formatting/Transfomation module (24) will reconfigure internet content originally designed for computer monitor resolution and aspect ratio to the resolution and aspect ratio of televisions or other devices as appropriate. This module enables television viewers access to internet data and content. It also translates content into formats that can be read by devices other than the television and the personal computer.

A Video Server/Stream Manager (19) provides storage of video content and has the capability to deliver multiple video streams independently to end users as requested. The network operator stores video content provided by business partners on the server. In response to end user requests which come through the support modules mentioned above (AAA server, etc.) the video server initiates a video stream destined for the user. The server has the capability to provide an appropriate number of simultaneous video streams based on the demand expected by the network operator.

An Advertising Insertion module (20) controls delivery of advertising from an ad server to end users. The advertising typically is tailored to individual end users through information they provide to the targeting and profiling module. When a user submits a request for video, audio or data, a corresponding request is sent to the Ad Insertion module. The module selects an appropriate ad and bundles it with the content being requested by the user. The user receives both the requested content and the advertising.

The system includes a Bandwidth Manager (21) module which tracks bandwidth usage by individual users on a real-time basis. Each user is allocated a set amount of bandwidth. If a user submits requests for content which exceed the allocated amount of bandwidth, the Bandwidth Manager indicates that fulfilling the requests would exceed allocated bandwidth. The network operator can choose how to deal with the request based on policies and user information.

A Multicast Proxy server module (22) provides proxy facilities for multicast queries. This module translates or redirects multicast queries into unicast queries. The module stores and manages information in a file server based on information from the Subscriber Management module of the network OSS.

A series of modules which enable and enhance user interaction with the system are contained in a User Interface (UI)/Set Top Box (STB) grouping. These modules are downloaded by the network operator into the Set Top Box equipment located at the end user premises.

An Experience Engine (26) module holds the UI look and feel and this can be modified by the end user or the network operator based on perceived preferences of the user.

A Content Engine (27) encompasses applications that enable various content to run, operate or be displayed on the device currently in use by the end user. The Content Engine provides content management at the user end of the network.

A Shopping Engine (28) establishes a system for commerce through the network by providing a vital link to retail partners and inventory and a method for collecting, distributing and tracking revenues which are generated through such transactions.

What is claimed is:

1. An integrated content delivery system for storing, managing and delivering electronic content to a plurality of subscribers, comprising:
a plurality of computer servers coupled together; and
a software platform distributed and collectively executed on the plurality of computer servers, comprising:
a content delivery platform including a plurality of modules that store electronic content and that provide selected electronic content for delivery;
an operating support system, interfaced to the plurality of subscribers, that performs network management and that facilitates delivery of electronic content to the end users;
a business support system, interfaced to the operating support system, that manages subscriber devices and electronic content delivery to subscribers and that performs billing functions associated with electronic content delivered to subscribers; and
a database platform, interfaced to the content delivery platform and the business support system, that serves as a repository for information flowing between the content delivery platform and the business support system.

2. The integrated content delivery system of claim 0, wherein the business support system further comprises:
a subscriber management module that manages subscriber devices and electronic content delivery to subscribers including tracking and assigning subscriber devices at subscriber premises; and
a billing module that captures, rates, and generates billing information based on subscriber activity.

3. The integrated content delivery system of claim 2, wherein the billing module further exports billing information in a format compatible with at least one service provider.

4. The integrated content delivery system of claim 2, further comprising:
the integrated content delivery platform including an event tracking and logging module that monitors usage of specific electronic content by each end user; and
a targeting and profiling module that aggregates data from the subscriber management module and the event tracking and logging module to build an overall set of preferences for each end user.

5. The integrated content delivery system of claim 0, wherein the integrated content delivery platform includes an authentication, authorization and audit module that confirms the identity of each subscriber, that evaluates authorization of each subscriber to receive selected electronic content, and that tracks overall system usage by each subscriber.

6. The integrated content delivery system of claim 0, wherein the integrated content delivery platform includes an event tracking and logging module that monitors usage of specific electronic content by each subscriber.

7. The integrated content delivery system of claim 0, wherein the integrated content delivery platform includes a digital asset management module that stores, tracks and indexes metadata associated with digital assets.

8. The integrated content delivery system of claim 7, wherein the metadata includes ownership data, rights data, time envelopes data, price data and marketing data pertaining to specific electronic content.

9. The integrated content delivery system of claim 8, wherein the time envelopes data defines an amount of time that a subscriber is allowed to access specific electronic content associated with a content request.

10. The integrated content delivery system of claim 8, wherein the marketing data includes information about specific electronic content which is useful in establishing the propensity for subscribers to request that electronic content.

11. The integrated content delivery system of claim 8, wherein specific electronic content includes video, audio, games, software, applications and services available for down load or real time interaction.

12. The integrated content delivery system of claim 0, wherein the integrated content delivery platform includes a targeting and profiling module that tracks subscriber preferences and that develops targeted content which meets subscriber preferences.

13. The integrated content delivery system of claim 0, wherein the integrated content delivery platform includes a caching module that provides a storage and delivery solution for electronic content.

14. The integrated content delivery system of claim 13, wherein the caching module caches Internet content to allow delivery to subscribers.

15. The integrated content delivery system of claim 0, wherein the integrated content delivery platform includes a high speed caching module to provide faster delivery and enhanced content richness to subscribers.

16. The integrated content delivery system of claim 0, wherein the integrated content delivery platform includes a formatting and transformation module that reconfigures video content for display on a selected subscriber device.

17. The integrated content delivery system of claim 16, wherein the formatting and transformation module reconfigures aspect ratio and resolution of the video content.

18. The integrated content delivery system of claim 0, wherein the integrated content delivery platform includes a stream manager module that stores video content and that delivers independent multiple video streams to subscribers upon request.

19. The integrated content delivery system of claim 18, further comprising:
a video server capable of providing multiple simultaneous video streams to subscribers.

20. The integrated content delivery system of claim 0, further comprising:
an advertising server; and
the integrated content delivery platform including an advertising insertion module that controls delivery of advertising from the advertising server to subscribers.

21. The integrated content delivery system of claim 20, further comprising:
a targeting and profiling module that tracks subscriber preferences and that develops targeted content which meets the subscribers preferences; and
wherein the advertising insertion module selects advertising based on subscriber preferences and bundles selected advertising with electronic content requested by each subscriber.

22. The integrated content delivery system of claim 21, wherein the targeting and profiling module performs collaborative filtering of electronic content and advertising based on subscriber browsing activity and content purchases.

23. The integrated content delivery system of claim 0, wherein the integrated content delivery platform includes a bandwidth manager that tracks bandwidth usage by subscribers in real-time.

24. The integrated content delivery system of claim 0, wherein the integrated content delivery platform includes an address resolution server module that provides proxy facilities for multicast queries by redirecting multicast queries into unicast queries.

25. The integrated content delivery system of claim 24, wherein the address resolution server module stores and manages subscriber information.

26. The integrated content delivery system of claim 0, further comprising:
a user interface module that incorporates at least one module that is downloaded and executed on a subscriber device.

27. The integrated content delivery system of claim 26, wherein the user interface module includes an experience engine module that incorporates subscriber operation preferences of a subscriber device while executed on a subscriber device.

28. The integrated content delivery system of claim 26, wherein the user interface module includes a content engine module that provides content management at a subscriber premise while executed on a corresponding subscriber device and that encompasses applications that enable various content to run, operate or be displayed on the subscriber device.

29. The integrated content delivery system of claim 26, wherein the user interface module includes a shopping engine module that provides links to retail partners and inventory and that collects, distributes and tracks revenues which are generated by associated transactions while executed on a subscriber device.

30. An interactive content delivery system, comprising:
a software platform that includes multiple types of electronic content for delivery to end users;
an end user interface, interfaced to the software platform, that facilitates delivery of the multiple types of electronic content; and
at least one end user interactive display device, interfaced to the end user interface, that receives and displays the multiple types of electronic content;
wherein the software platform and the end user device cooperate to deliver and display multiple types of content simultaneously on the end user device, the multiple types of content including broadband content and narrowband content, and wherein the end user device enables a user to interact with each of the multiple types of content simultaneously.

31. The interactive content delivery system of claim 30, wherein the software platform and the end user device cooperate to enable the user to seamlessly switch between the narrowband and broadband content.

32. The interactive content delivery system of claim 30, wherein the software platform and the end user device cooperate to enable the user to browse through narrowband content while the user device is displaying the broadband content.

33. The interactive content delivery system of claim 32, wherein the software platform and the end user device cooperate to enable the user to pause the broadband content at any time.

34. The interactive content delivery system of claim 30, wherein the narrowband content includes a selected combination of text, graphics and video that is associated with operation of the broadband content so that the user may modify operational and display characteristics of the broadband content by interacting with the narrowband content.
